(19) United States
(12) Patent Application Publication
(10) Pub. No.: US 2022/0119147 A1
(43) Pub. Date: Apr. 21, 2022

(54) COLLAPSIBLE BOTTLE AND FILLING STATION

(71) Applicant: STRAUSS GROUP LTD., Petach-Tikva (IL)

(72) Inventors: Dagan ESHEL, Yahud Monoson (IL); Yiftah SERI, Mevasseret-Zion (IL); Inbal HALPERIN, Ramat HaSharon (IL); Hagai HARDUFF, Binyamina (IL); Duncan Robert SHEA-SIMONDS, Leicester, Leicestershire (GB); Dan LONGMAN, Leicester, Leicestershire (GB); Amit AVIGDOR, Kibbutz Bahan (IL)

(73) Assignee: STRAUSS GROUP LTD., Petach-Tikva (IL)

(21) Appl. No.: 17/310,816

(22) PCT Filed: Feb. 25, 2020
(86) PCT No.: PCT/IL2020/050209

§ 371 Date: Aug. 25, 2021

(30) Foreign Application Priority Data
Feb. 25, 2019 (IL) 265049

(51) Int. Cl. B65D 1/02; B65D 21/02; B67C 3/02; B67C 3/22; B67C 7/00

(52) U.S. Cl. CPC B65D 1/0292; B65D 1/0276; B65D 21/0231; B67C 3/023; B67D 7/00; B67C 7/004; B65D 2501/0036; B67C 2007/006; B67C 2007/0066; B67C 3/225

(57) ABSTRACT

Provided is a bottle which includes a neck portion configured to receive a cap to seal the bottle, a lower portion including a bottom on which the bottle is configured to stand erect, an upper portion extending from the neck portion to the lower portion and an annular rib. The annular rib defines a transition between the lower portion and the upper portion and protrudes outwardly with respect to both the upper portion and the lower portion of the bottle. The upper portion, lower portion and annular rib are portions of a single entity formed from one material. The upper portion is configured to reversibly collapse into the lower portion.

### RELATED APPLICATION

This application claims the benefit of priority from Israel Patent Application No. 265049 filed on Feb. 25, 2019, the contents of which are incorporated herein by reference in their entirety.

### FIELD AND BACKGROUND OF THE INVENTION

The present invention, in some embodiments thereof, relates to a bottle and a bottle filling station and, more particularly, but not exclusively, to collapsible plastic bottle and filling station for filling the bottle on demand.

Many beverages including water are sold in bottles. Bottled beverages are available in different sizes including personalized sizes for people on the go. Personalized sized bottled beverages are known to be available in vending machines as well as other points of sale. It is also known, that personalized sized bottled beverages, in particular and bottled beverages in general are wasteful to the environment. Furthermore delivery of the bottled beverages to various points for sale is known to be costly. An additional concern associated with bottled beverages is their shelf life. Both the material and thickness of known bottles for beverages are required to provide a desired shelf life and adequate robustness to stay intact while being transported and stored. For plastic bottles, this requirement adds additional environmental concerns.

U.S. Pat. No. 5,860,556, entitled “Collapsible storage container,” the contents of which are incorporated herein by reference describes a single fold collapsible container including a peripheral side wall extending upwardly from a bottom wall, and terminating at an upper open end. The side wall has upper and lower portions separated by a peripheral fold line having a sideways S-shaped geometry such that the upper and lower portions are movable relative to one another between extended and collapsed positions. In a second embodiment it is described that movement into the collapsed state is by pushing the upper wall portion down to the lower portion so that the upper portion undergoes reverse folding. A shoulder portion extending from the upper wall portion to the rim stays intact during the collapsing movement. In this embodiment, it is described that the upper side wall portion has a wall thickness less than the lower portion.

International Patent Application Publication No. WO 2014/102793, entitled “Container,” the contents of which are incorporated herein by reference describes a bottle that has a flexible portion coupled to a rigid portion, at one end thereof and to a rigid neck portion on the other end. The flexible portion may be coupled to the rigid portion by welding. In a collapsed state, the flexible portion (upper portion) is folded inside the rigid portion (bottom portion) such that the neck portion reaches the bottom of the rigid portion. It is described that a plurality of bottles can be stacked up one inside the other in the collapsed state. The bottle may be filled by an automatic filling system through a filling valve included at the bottom of the rigid portion, while the neck portion is covered with a cap. Materials described for the flexible portion are other than materials described from the rigid portion.

### SUMMARY OF THE INVENTION

According to an aspect of some embodiments of the present invention there is provided a self standing bottle that is configured to be stored at a point of sale in a collapsed state and to be erected or expanded as it is filled with a beverage on demand at the point of sale. In some example embodiments, the bottle is a plastic bottle that is relatively light weight and has a defined construction that provides both stability and comfort when handling. Optionally, the bottle weighs between 9-15 gm and provides a volume of between 250-1,000 ml in particular 550 ml. According to some example embodiments, the bottle is formed with blow molding with a single material. In some example embodiments, the bottle material is polyethylene terephthalate (PET). PET material is advantageous in that it is durable, recyclable and does not impart an aftertaste in contents of the bottle. In alternative examples, the bottle may be formed from Polyethylene Terephthalate Glycol (PETG), Polyethylene naphthalate (PEN), Polypropylene (PP), High-density polyethylene (HDPE) or Tritan™. Tritan is a material manufactured by Eastman in Kingsport, Tenn.

According to an aspect of some embodiments of the present invention there is provided a filling station that is configured to store a stack of bottles with caps in a collapsed state, fill a bottle from the stack through a neck portion of the bottle after removing the cap and while expanding the bottle, cap the bottle and then dispense the bottle to an end customer. The filling station may be connected to a fluid source, e.g. water source. The filling station may include one or more filters or purifying mechanism for treating the beverage and may also include additives. Optionally, the filling station is in the form of a vending machine.

According to an aspect of some example embodiments, there is provided a bottle including: a neck portion configured to receive a cap to seal the bottle; a lower portion including a bottom on which the bottle is configured to stand erect; an upper portion extending from the neck portion to the lower portion; an annular rib defining transition between the lower portion and the upper portion; wherein the upper portion, lower portion and annular rib are portions of a single entity formed from one material, wherein the upper portion is configured to reversibly collapsed into the lower portion and wherein the bottle in its erected state is configured to be self-standing while empty.

Optionally, the entire upper portion between the neck portion and the annular rib is configured to be reversibly inverted.

Optionally, the thickness of the upper portion and the lower portion is uniform.

Optionally, the thickness of the upper portion, lower portion and annular rib is uniform.

Optionally, the thickness of the material forming the upper portion, lower portion and annular rib is 0.3-0.6 mm.

Optionally, the bottle is configured to weigh less than 14 gm and hold a capacity of at least 550 ml.

Optionally, the bottle is formed by an injection molding process followed by a blow molding process.

Optionally, the bottle is formed with a transparent polymer material.

Optionally, the transparent polymer material is polyethylene terephthalate (PET).

Optionally, the annular rib defines the maximum diameter of the bottle and wherein both the upper portion and the lower portion taper distal from the annular rib.

Optionally, a diameter of the annular rib is between 75-95 mm and a height of the bottle is between 160-170 mm.

Optionally, an aspect ratio of the bottle is 0.4-0.7.

Optionally, the upper portion includes fold lines forming a pattern of polygons.

Optionally, the pattern of polygons is a pseudo-random pattern of polygons.

Optionally, the pattern of polygons includes polygons with variable sizes.

Optionally, sizes of the polygons have decreasing gradient toward the neck portion of the bottle.

Optionally, the pattern of polygons includes polygons that are variable in shape.

Optionally, the lower portion is formed with a plurality of rings protruding toward an inner volume of the bottle.

Optionally, the bottom is formed with a recess that is sized and shaped to receive a cap of another bottle.

According to an aspect of some example embodiments, there is provided a stack of bottles including a plurality of bottles described herein in a collapsed configuration, wherein each of the bottles includes a cap and wherein a bottom of one bottle is fitted over the cap of another bottle.

Optionally, a portion of the bottom of each of the bottles in the stack is raised and wherein a diameter of the raised portion is sized to receive the cap of another bottle.

Optionally, a stacking pitch of the stack is between 31-34 mm.

Optionally, the bottles in the stack are configured to be released from the stack without urging separation between the bottles.

According to an aspect of some example embodiments, there is provided a filling station including: a releasing device configured to controllably release a bottle from a stack of collapsed bottles; a capping device configured to remove a cap from the bottle while the bottle is in a collapsed state and replace the cap after the bottle has been filled and erected; and a filling device configured to fill the bottle with a beverage through a neck portion of the bottle concurrently with erecting the bottle from the collapsed state to an expanded state; and a controller configured to control and coordinate operation of the releasing device, the capping device and the filling device.

Optionally, the filling station includes a dispensing window from which the bottle that is erected and filled with the beverage is dispensed.

Optionally, the filling device includes a support head configured to fit into a collapsed portion of the bottle and to guide erecting the collapsed portion of the bottle in a symmetrical manner.

Optionally, the support head has a truncated cone shape.

Optionally, the filling device includes a nozzle configured to engage the neck portion of the bottle and fill the bottle with a beverage through the neck portion.

Optionally, the support head is configured to be lifted passively as the bottle is being filled.

Optionally, the filling device includes a sealing probe configured to be received in the neck portion of the bottle and to form a sealed engagement with the neck portion of the bottle.

Optionally, the sealing probe comprises: a pipe configured to receive a hose from which the bottle is filled with the beverage; a sealing member fitted around the pipe, wherein the sealing member is a ring shaped element that is elastically compressible, the sealing member configured to form the sealed engagement with the neck portion of the bottle under compression; and an end cap attached to a distal end of the pipe, wherein the sealing member is configured to sit on the end cap.

Optionally, the sealing member is compressed based on lifting the sealing probe with respect to the support head to press the sealing member against a surface of the support head.

Optionally, the seal is released based on lowering the sealing probe with respect to the support head.

Optionally, the sealing probe is configured to be lifted and lowered within the support head based on a screw motion.

Optionally, erecting of the bottle is based on pressure accumulated in the bottle as the beverage flows into the bottle.

Optionally, the filling device is fluidly connected to a tap water line external to the filling station.

Optionally, the filling station includes a treating unit configured to treat water received from the tap water line, wherein the filling station is configured to fill the bottle with the water treated by the treating unit and wherein the treating unit includes one or more of: a cooling unit configured to cool the tap water, a purification unit configured to filter the tap water, a carbonation unit configured to carbonate the tap water and an flavoring unit configured to add minerals and/or flavoring to the tap water.

Optionally, the releasing device is configured to release the bottle from the stack based on allowing the bottle to drop from the stack.

Optionally, the releasing device includes a retractable platform positioned to support a bottom of the stack and to temporarily retract from the bottom of the stack to release a bottle.

Optionally, the releasing device includes a clasp configured to clasp an edge of bottle stacked over a bottle that is being released.

Optionally, the filling station includes a carousel configured to support a plurality of stacks of collapsed bottles.

Optionally, the filling station includes a horizontal stage configured to advance the bottle between the capping device and the filling device.

According to an aspect of some example embodiments, there is provided a method of filling a collapsed bottle, wherein the collapsed bottle includes a neck portion, an upper portion extending from the neck portion and inverted into a lower portion of the bottle, the method including: holding the lower portion of the collapsed bottle; engaging a support head with the neck portion of the bottle, wherein the support head is configured with a same curvature and size as the upper portion in its collapsed state; directing a nozzle or hose through the support head to the neck portion of the bottle; and filling the bottle with a beverage, wherein the filling is configured to raise the support head.

Optionally, a shape of the support head is configured to support gradually reversing inversion of the upper portion, wherein the reversing begins proximal to the lower portion and ends proximal to the neck portion.

Optionally, the support head is configured to rise passively as the bottle is being filled based on the filling.

Optionally, the method includes releasing the collapsed bottle from a stack of collapsed bottles; uncapping the collapsed bottle prior to the filling; and capping the bottle after the filling.

Optionally, the nozzle or hose is connected to a tap water line and further including treating the water received from the tap water line by one or more of: cooling, filtering, carbonating, adding minerals and adding flavoring to the tap water.

According to an aspect of some example embodiments, there is provided a bottle collapsing apparatus including: a holding device configured to receive a lower portion of the bottle, the lower portion including a bottom on which the bottle stands; a gripping device configured to grip an annular rib formed on the bottle between the lower portion and an upper portion, the upper portion extending from the annular rib to a neck portion of the bottle; and a shaping head configured with a same size and shape as an upper portion of the bottle in a collapsed state.

Optionally, the gripping device is configured to grip the annular rib encompassing a diameter of the bottle between the upper portion and the lower portion.

Optionally, the gripping device includes a plate with a bore through which the upper portion of the bottle may be erected and wherein the plate is configured to press against the annular rib.

Optionally, the shaping head includes a cavity configured to receive a neck portion of the bottle.

According to an aspect of some example embodiments, there is provided a method for inverting an upper portion of a bottle into a lower portion of a bottle, wherein the bottle includes a neck portion, an upper portion and a lower portion, the upper portion extending from the neck portion to the lower portion and the lower portion including a bottom on which the bottle stands and wherein an annular rib is formed between the upper portion and the lower portion, the method including: holding the lower portion of the bottle; gripping the annular rib; and pressing the neck portion toward the bottom of the bottle with a shaping head, wherein the shaping head is configured with a same size and shape as the upper portion of the bottle in a collapsed state.

Optionally, the shaping head includes a cavity configured to receive the neck portion of the bottle.

Optionally, the shaping head is configured to guide gradual inversion of the upper portion starting from the neck portion and ending at the annular rib.

Optionally, the gripping is based on pinching the annular rib.

Unless otherwise defined, all technical and/or scientific terms used herein have the same meaning as commonly understood by one of ordinary skill in the art to which the invention pertains.

Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced. In the drawings:

FIG. 1A is a front view of an example bottle with a cap in accordance with some example embodiments;

FIGS. 1B, 1C and 1D are front, top and bottom views respectively of an example bottle without the cap, all in accordance with some example embodiments;

FIGS. 2A and 2B are perspective and inner front views of a mold for an example bottle, both in accordance with some example embodiments;

FIG. 3 is a perspective view of an example bottle in a collapsed state in accordance with some example embodiments;

FIGS. 4A, 4B and 4C are perspective, front, and detailed cross-sectional views respectively of an example stack of collapsed bottles in accordance with some example embodiments;

FIG. 5 is a perspective view of an example package of stacked bottles each in a collapsed stated in accordance with some example embodiments;

FIGS. 6A and 6B are front and top views respectively of an example filling station in accordance with some example embodiments;

FIGS. 7A, 7B, 7C, 7D, 7E, 7F, 7G, 7H are simplified schematic block diagrams of an example filling station performing a series of example operational steps to fill a bottle on demand, all in accordance with some example embodiments;

FIG. 8 is a simplified flow chart of an example method to provide a bottle filled with a beverage in accordance with some example embodiments;

FIGS. 9A, 9B, 9C, 9D, and 9E are simplified schematic block diagrams of a collapsing apparatus performing a series of example operational steps for collapsing an example self-standing bottle, all in accordance with some example embodiments;

FIG. 10 is an example collapsing apparatus configured for controllably collapsing the example self-standing bottle in accordance with some example embodiments;

FIG. 11 is a simplified flow chart of an example method to manufacture stacks of collapsed bottles in accordance with some example embodiments;

FIGS. 12A, 12B, and 12C are drawings of another example filling station shown in three different operative states, all in accordance with some example embodiments;

FIGS. 13A and 13B are details of the example filling station of FIGS. 12A-12C engaged with a bottle in a neutral and sealed operative state respectively, both in accordance with some example embodiments; and

FIG. 14 is an exploded view of an example sealing probe in accordance with some example embodiments.

### DESCRIPTION OF SPECIFIC EMBODIMENTS OF THE INVENTION

The present invention, in some embodiments thereof, relates to a bottle and a bottle filling station and, more particularly, but not exclusively, to collapsible plastic bottle and filling station for filling the bottle on demand.

According to some example embodiments, there is provided a bottle that is configured to be filled with water and/or other beverage and capped at a point of sale and then immediately dispensed to a customer. According to some example embodiments, the bottle is a self standing (or self carried) bottle that is optionally transparent and optionally formed from PET. The bottle is configured to be a light weight bottle that may be reversibly collapsed. Collapsing as used herein means that the upper half of the bottle collapses into a lower half of the bottle while the lower portion of the bottle stays intact, e.g. geometry of the lower portion is maintained intact. Collapsing of the bottle is configured to facilitate stacking of the bottles. Dimensions and geometry of the bottle are defined to provide compact stacking of the collapsible without sticking between the collapsed bottles and as well as relatively easy erecting or expansion of the bottles on demand. In some example embodiments, the stack although compact provides free release of a bottle from the stack without the need to physically urge a collapsed bottle away from the stack. Optionally, 3-5 collapsed bottles may be stacked over a same height that an erected bottle would take. Expansion or erecting as used herein refers to pulling the upper half of bottle out from the lower half of the bottle.

According to some example embodiments, the upper half of the bottle includes a pattern designed to conceal or blur wrinkle lines that may form on the upper half of the bottle due to the collapsing and expanding operation. The pattern is also configured to provide a visual effect making the contained beverage looked iced or chilled. Optionally, the patter is a pattern of polygons. Optionally, the polygons are designed with a decreasing gradient toward a neck portion of the bottle to enhance the visual effect that the pattern of polygons provides. In some example embodiments, the bottles are formed from transparent plastic, e.g. polyethylene terephthalate (PET).

Since the bottles as described herein are configured to be filled on demand they may be formed in a relatively less robust manner, e.g. with less plastic as compared to bottles that may be filled at a manufacturing site, stored over an extended time prior to reaching a point of sale and being bought by a customer. Reducing weight of the plastic for the bottle is more cost effective and more environmental friendly. In some example embodiments, each bottle may provide a capacity of 250-1000 ml, e.g. 550 ml and may only weigh 9-15 gm, e.g. 13 gm. In some example embodiments, the bottle has a constant wall thickness along its height (both upper and lower half are formed with same wall thickness). Optionally, wall thickness is between 0.3-0.6 mm, e.g. 0.45. In alternative embodiments, the wall thickness of the upper portion is defined to be other than the defined wall thickness of the lower portion.

In some example embodiments, the lower half of the bottle may be formed with a plurality of rings encompassing the bottle to impart more stability to the bottle despite its light weight. In some example embodiments, the bottle may additional include an annular rib at the seam between the upper half and lower half that may add strength to the bottle structure in an area that is typically grasped when holding the bottle. Optionally, the annular rib is functional during the collapsing process by providing a structure that may be held or pinched to control the collapsing process and obtain a defined collapsed shape. In some example embodiments, the bottle is constructed such that a wall thickness of the annular rib is thicker than the wall thickness forming the upper half or both the upper half and the lower half of the bottle. In some example embodiments, the cap on the bottle may not require a tamper evident seal which may also contribute to reducing the amount of plastic used in the cap as well as in the neck portion of the bottle. When eliminating the tamper evident seal, the height of the neck portion of the bottle may be shortened. According to some example embodiments, the construction of the bottle is configured to provide a visual appearance of bottles that have not been collapsed and that are robust despite their low weight.

According to some example embodiments, aspect ratio (width over height) of the bottle is defined to be between 0.4-0.7, e.g. 0.5. An aspect ratio below 0.4 may make it difficult to transition between a collapsed and expanded state of the bottle. An aspect ratio above 0.7 may be uncomfortable to grip and may tend to collapse based on gripping. A desirable aspect ratio may also depend on material properties of the bottle material and/or thickness of the bottle material.

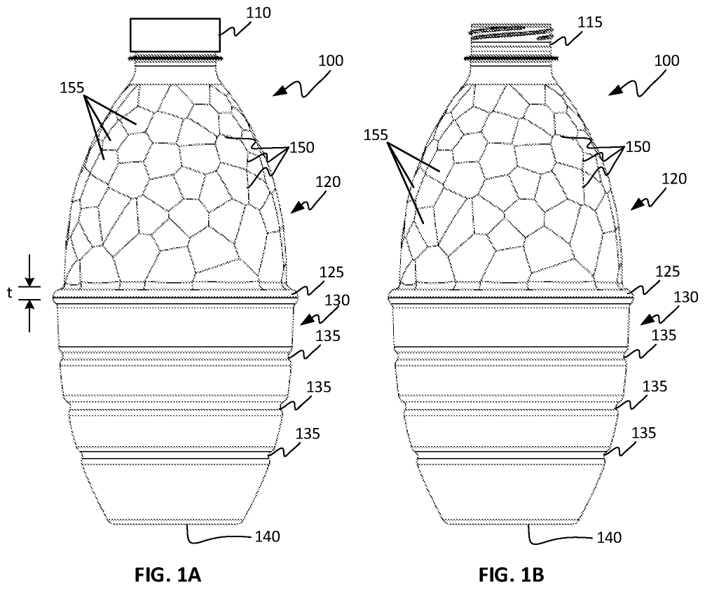

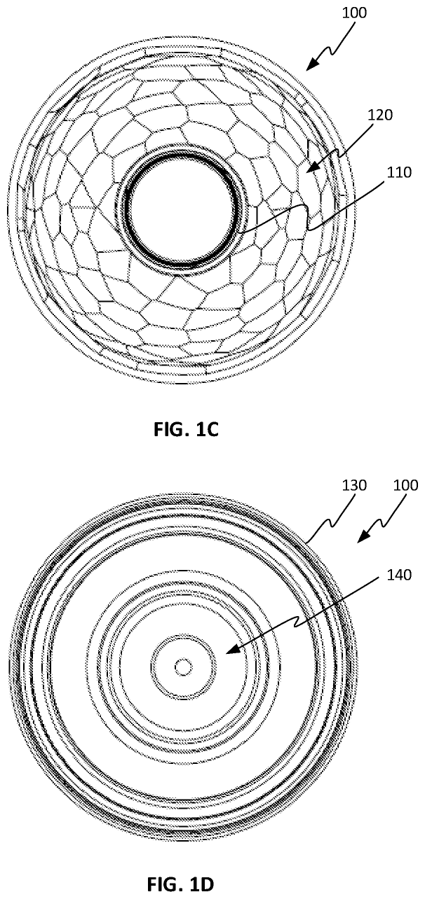

According to some example embodiments, the bottles while in a collapsed state are capped and stacked. The bottles may also be sterilized prior to capping. Optionally, the stacked bottles may be loaded into a filling station, e.g. a vending machine. The vending machine may release and fill the bottles with a beverage on demand. The beverage may be water. Optionally, the filling station is fluidly connected to a tap water line that may be used to fill the bottles. In some example embodiments, filling of a bottle occurs as the bottle is expanded. Optionally, the water from the tap water line may be treated prior to dispending into a bottle. For example the water may be cooled, filtered, otherwise purified, carbonated, and/or enriched with flavor and/or functional ingredients. In some example embodiments, due to the compact construction of the collapsed bottle, a filling station that is sized as a typical vending machine may have a capacity of storing between 700 and 1,200 bottles in a collapsed stacked state. Before explaining at least one embodiment of the invention in further detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways. Referring now to the drawings, FIGS. 1A showing a front view of an example bottle with a cap and to FIGS. 1B, 1C, and 1D showing front, top and bottom view respectively of the same example bottle without the cap, all in accordance with some example embodiments. A bottle 100 includes an upper portion 120 optionally formed to include a pattern 155, e.g. a pattern of polygons. Optionally the pattern is formed with a plurality of fold lines 150 that defined the pattern of polygons. Upper portion 120 is the portion of bottle 100 between a neck portion 115 configured to receive a cap 110 and an annular rib 125. Lower portion 130 extends from annular rib 125 to bottom 140 forming a bottom surface on which bottle 100 stands. Optionally, lower portion is formed with a plurality of rings 135 that are spaced part and each of which encompasses bottle 100. Rings 135 may be formed as recesses on lower portion 130, e.g. indented into lower portion 130. Optionally, a bottle 100 may include 2-6 rings 135, e.g. 3 rings. Annular rib 125 may protrude outwardly from a surface of bottle 100 and may define the widest part of bottle 100 and is formed at a seam between upper portion 120 and lower portion 130.

In some example embodiments, a widest portion of annular rib 125 is configured with a diameter that is 1-8 mm for example 3-4 mm more than a widest diameter of each of upper portion 120 and lower portion 130. A height or thickness ‘t,’ of the annular rib 125 along a height of bottle 100 may be between 3-8 mm depending on a height of bottle 100. Optionally, upper portion 120 and lower portion 130 are substantially the same size, e.g. hold a same volume. According to some example embodiments, bottle 100 is formed from single material, e.g. PET material in a blow molding process.

According to some example embodiments, bottle 100 is a light weight personalized sized plastic bottle that holds a volume of 250-1,000 ml, e.g. 550 ml. Other sizes, smaller and larger than 550 ml may be contemplated. Bottle 100 is configured to be self-standing even when empty and reversibly collapsible, e.g. upper portion 120 may collapse into lower portion 130 for storing and then expanded during filling. Optionally, bottle 100 is 150-190 mm tall e.g. 173 mm and 70-100 mm, e.g. 85 mm wide and may weigh 9-15 gm, e.g. 13 gm. For larger volume capacity within the range of 250-1,000 ml, bottle 100 may be 190-220 mm in height e.g. 210 mm and 90-120 mm in diameter, e.g. 105 mm and may weigh 20-30 gm, e.g. 25 gm. Construction of bottle 100 is configured to impart a look and feel of a robust bottle in spite of is relatively light weight. According to some example embodiments, fold lines 150 form pattern 155, e.g. a pattern of polygons that are configured to camouflage and/or blur wrinkle lines that may occur while collapsing and expanding upper portion 120 and may also camouflage mold parting lines. In some example embodiments, a pattern formed with fold lines 150 may be defined to form shapes that are variable in size with an optional decreasing gradient toward neck portion 115. Optionally, pattern 155 is a pattern of polygons and may also provide a glacial look that may be visually pleasing.

Optionally, pattern 155 may provide a milky look to upper portion 120. Pattern 155 may also be formed with dots, curved fold lines or other textures that provide a pattern that is other than a pattern of polygons.

Optionally, annular rib 125 is configured to provide structural support for gripping bottle 100. Optionally, annular rib 125 is the widest portion of bottle 100 with diameter 75-95 mm, e.g. 88 mm. Width of annular rib 125 may be configured to provide a comfortable grip for a customer while drinking and may also be configured to be wide enough to facilitate transition between a collapsed and expanded state of bottle 100. Optionally, annular rib 125 is functional during the collapsing process by providing a structure that may be held or pinched to control the collapsing process and obtain a defined collapsed shape. Optionally, protrusion of annular rib provides a surface area that may be gripped during the collapsing process. Annular rib 125 may protrude out by 1-8 mm. Diameter of bottle 100 in both lower portion 130 and upper portion 120 may taper distal from annular rib 125. Optionally, diameter of annular rib 125 and a degree of tapering is defined to provide a desired stacking configuration when in a collapsed state, e.g. while upper portion 120 is collapsed into lower portion 130. Optionally, the desired stacking configuration provides for releasing each bottle from the stack by dropping the bottle (based on gravity) without any need to urge separation between bottles in the stack. According to some example embodiments, bottle 100 is defined to have an aspect ratio (height over width) of 0.4-0.7, e.g. 0.5. According to some example embodiments, an aspect ratio of 0.4-0.7, e.g. 0.5 provides a small enough for diameter for comfortable gripping and storing in a backpack pocket on one hand and wide enough to facilitate collapsing and expanding of bottle.

In some example embodiments, angular rings 135 in lower portion 130 also provide structural support to prevent deformation of bottle 100 while held by a customer drinking from bottle 100.

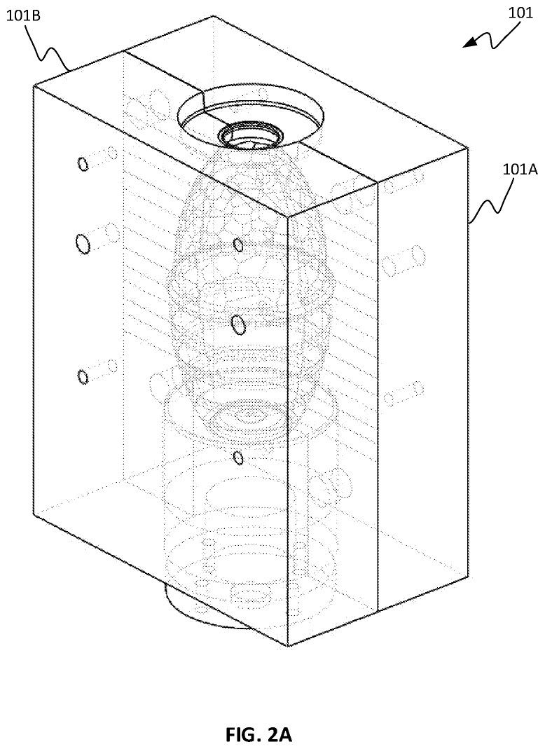

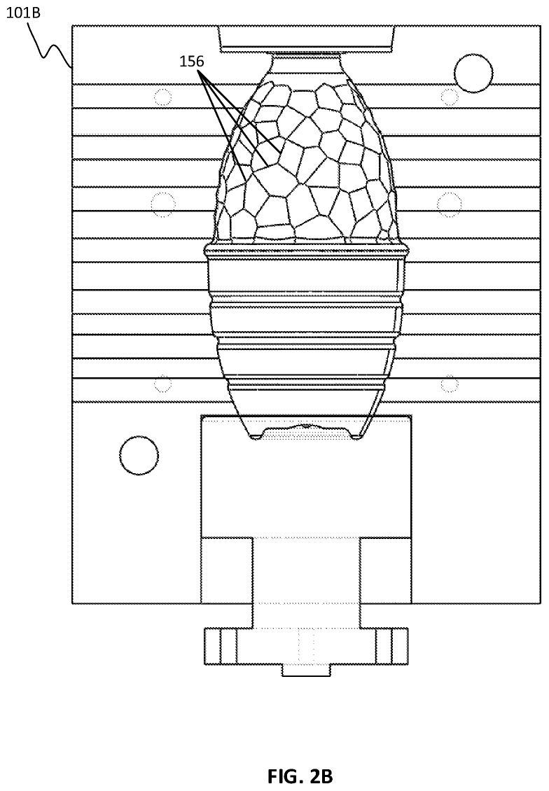

FIGS. 2A and 2B show a perspective and an inner front view of an example blow mold for an example bottle, both in accordance with some example embodiments. According to some example embodiments, bottle 100 may be formed in a blow molding process for example with mold 101. According to some example embodiments, fold lines 150 forming pattern 155 are defined and formed based on a corresponding pattern 156 included on each of a face 101A and 101B of mold 101.

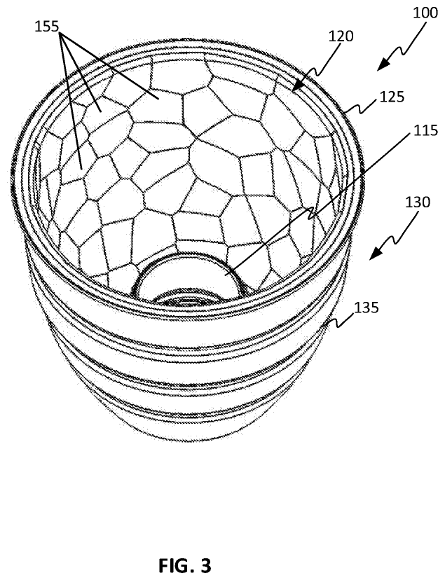

FIG. 3 shows a perspective view of an example bottle in a collapsed state in accordance with some example embodiments. According to some example embodiments, upper portion 120 of bottle 100 is configured to collapse into lower portion 130 of bottle 100 with upper portion 120 being inverted from neck portion 115 to annular rib 125. In the collapsed state, neck portion 115 is positioned near bottom 140 and annular rib 125 forms on an uppermost surface of the collapsed bottle. One or more of collapsing upper portion 120 into lower portion 130 of bottle 100 and expanding bottle 100 by raising upper portion 120 out of lower portion 130 may lead to wrinkles in upper portion 120. Wrinkles in upper portion 120 may be camouflaged and/or blurred due to pattern formed with fold lines 150.

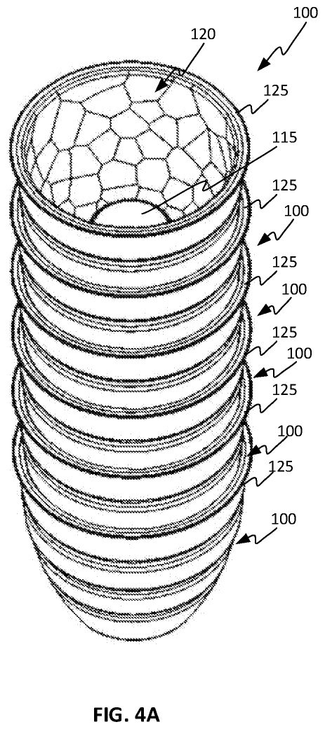

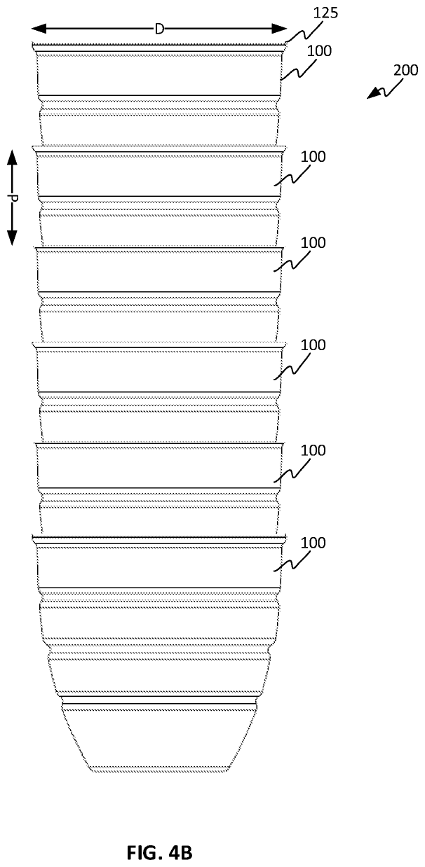

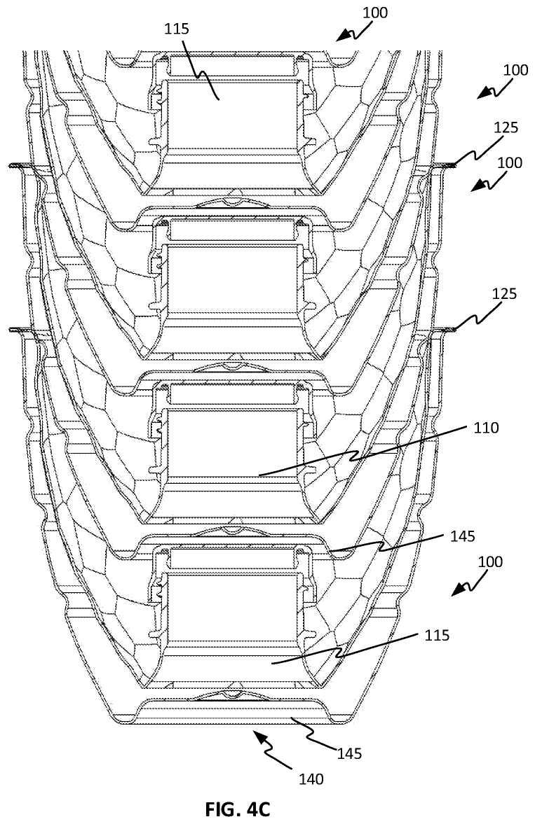

FIGS. 4A, 4B and 4C show perspective, front, and detailed cross-sectional views respectively of an example stack of collapsed bottles in accordance with some example embodiments. In some example embodiments, bottles 100 may be stacked while in a collapsed state and stored in a stack 200. Each bottle 100 may be removed from the stack and may be expanded to fill bottle 100 with a beverage on demand. Expanding or erecting as used herein refers to the act of lifting upper portion 120 out of lower portion 130. In some example embodiments, a stack pitch, P may be configured to be 30-40 mm, e.g. 33.5 mm. Optionally, the stack pitch affords stacking four bottles 100 in a space or height of one expanded bottle 100. The stacking pitch as well as a diameter, D, of rib 125 may provide compact stacking on one hand and easy release of a collapsed bottle from the stack on the other hand. Optionally, the presence of rings 135 also assist in avoiding sticking between bottles 100 in stack 200. Optionally, each bottle 100 is stacked with cap 110. In this manner, the bottles may be maintained sterile in storage.

Referring now in particular to FIG. 4C, in some example embodiments, bottom 140 of bottle 100 may include an indent or raised portion 145 that is sized to receive a portion of cap 110 and/or neck 115. For example, diameter of raised portion of bottom 140 may be sized to have a same or larger diameter than cap 110 and/or neck 115 so that cap 110 can be received in raised portion of bottom 140 and also be easily released from the raised portion. Raised portion 145 may increase compactness of stack 200.

FIG. 5 shows a perspective view of an example package of stacked bottles each in a collapsed stated in accordance with some example embodiments. In some example embodiments, a stack 200 of a pre-defined number of collapsed bottles may be packaged in a wrapping 220. Optionally, wrapping 220 is a flow pack wrapping.

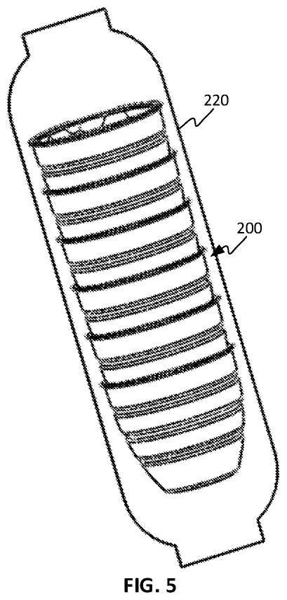

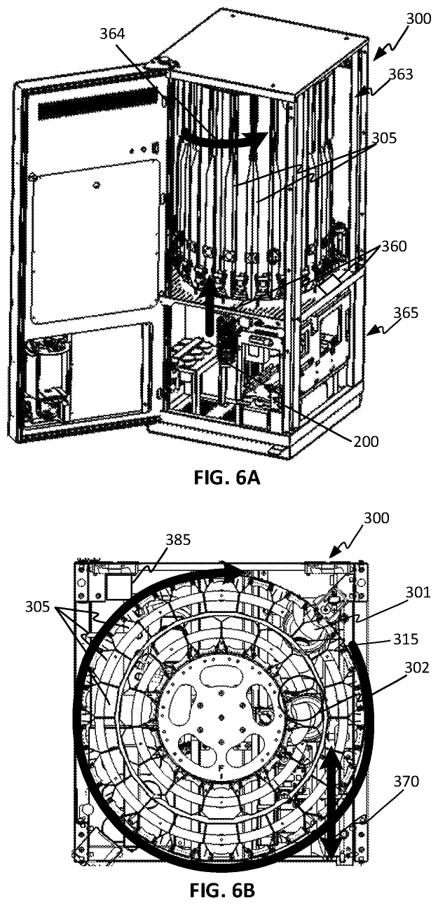

FIGS. 6A and 6B are front and top views respectively of an example filling station in accordance with some example embodiments. Optionally, a filling station 300 includes an upper shelf 363 for storing stacks 200 of collapsed bottles and a lower shelf 365 in which bottle 100 from stacks 200 may be received, filled and dispensed on demand. Optionally, stacks 200 are stored in dedicated tubes or containers 305 mounted on one or more concentric carousels on upper shelf 363. Each carousel may rotate (as shown with arrow 364) as needed to align one of stacks 200 with a bore 301 or 302 (FIG. 6B) through which a bottle from stack 200 may be released to lower shelf 330. Optionally, stacks 200 may also be loaded into tube 305 through bores 301 and 302 or alternatively through other bores 360 (FIG. 6A) dedicated for loading stacks 200 into filling station 300. Stack 200 may be loaded into tubes 305 without external packaging 220. Optionally, upper shelf 363 may be configured to be pulled out to facilitate loading stacks 200 in tubes 305. After each tube is loaded, carousel may rotate to allow the next tube 305 to be loaded. Optionally, when upper shelf 363 includes dedicated bores 360 for loading stacks 200, bores 360 may be closed at the end of the loading process.

Referring now specifically to FIG. 6B, in lower shelf 330, a carriage 315 configured to receive a bottle that is dropped may be carried on a horizontal stage 370, e.g. X stage. Horizontal stage 370 may align carriage 315 with a bore 301 or bore 302 of one of the concentric carousels that is presently being used to release bottles. According to some example embodiments, filling station 300 includes a controller 385 that is configured to control operation of filling station 300. For example, controller 385 may coordinate and control movement of carriage 315 with positioning of carousels in upper shelf 320. Controller 385 may also control movement of carousels during loading of stacks 200 in upper shelf 320.

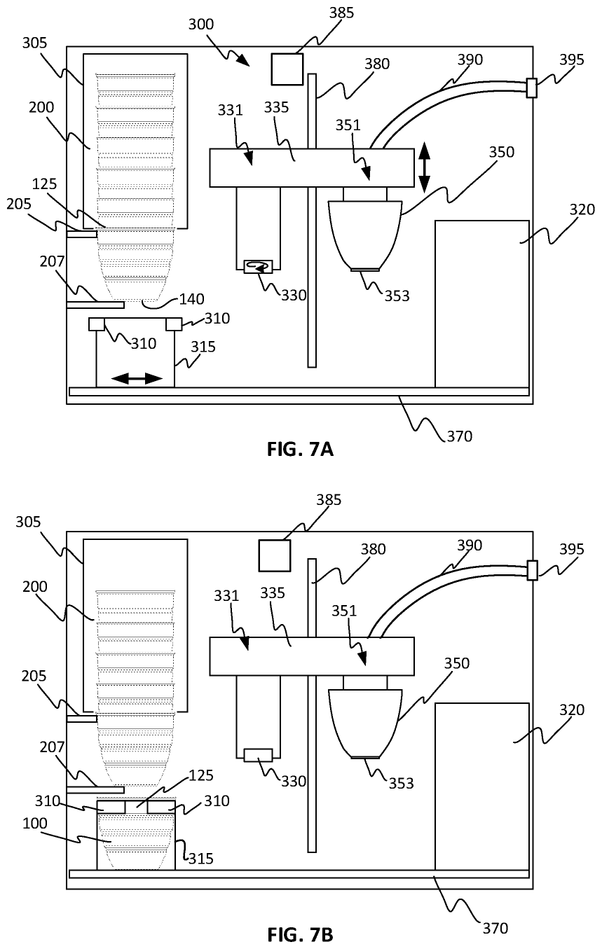

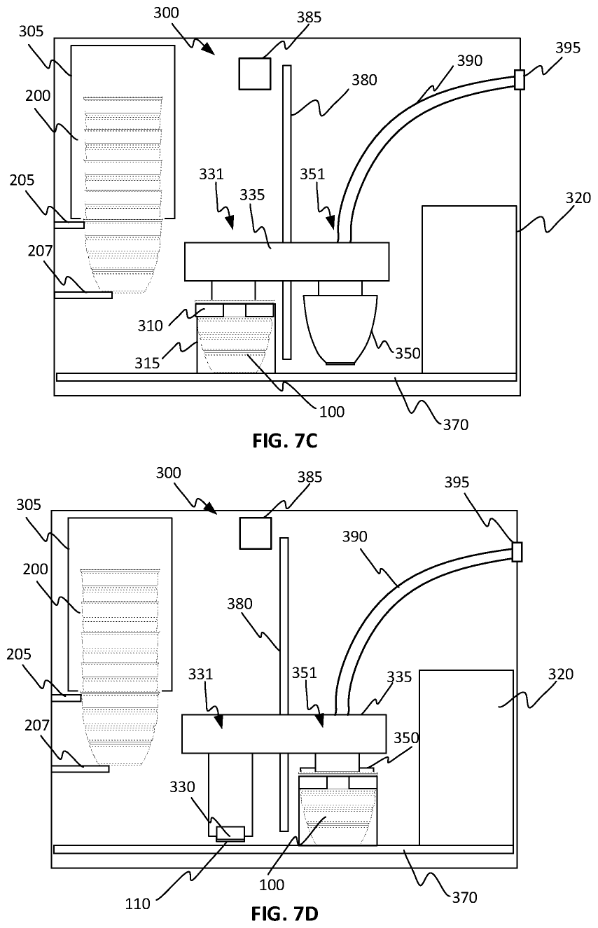

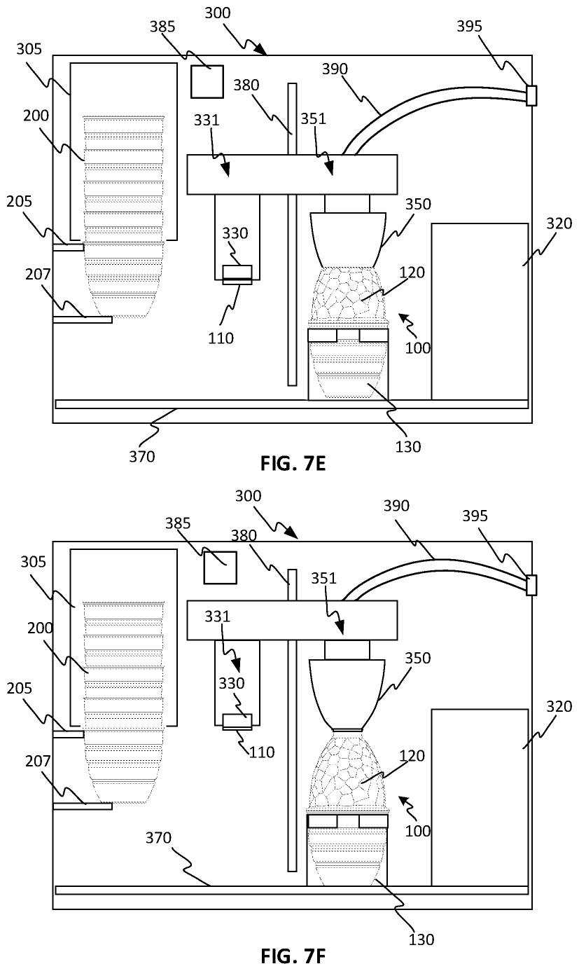

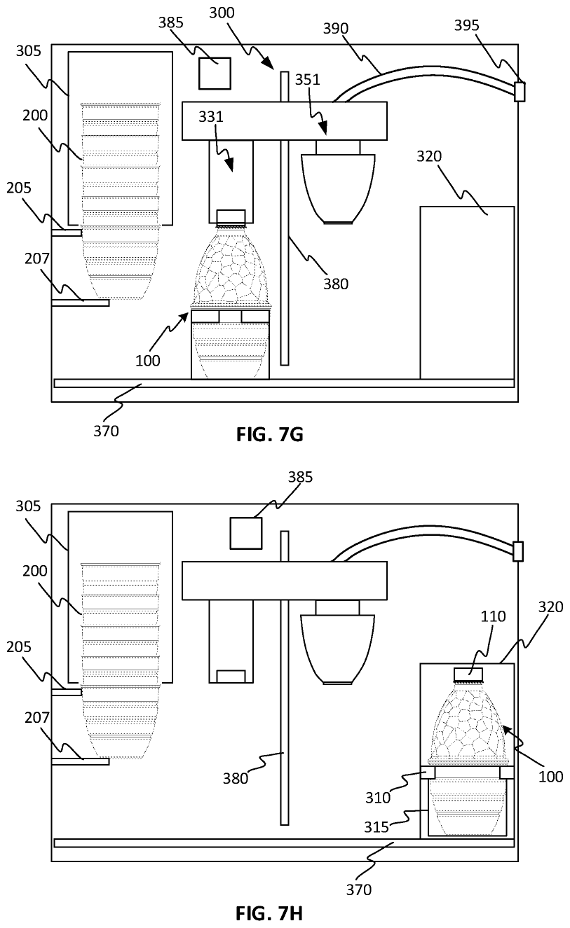

FIGS. 7A, 7B, 7C, 7D, 7E, 7F, 7G, and 7H show simplified schematic block diagrams of an example filling station performing a series of example operational steps to fill a bottle on demand, all in accordance with some example embodiments. According to some example embodiments, a carriage 315 on a horizontal stage 370 may be aligned with tube or container 305 housing stack 200 (FIG. 7A).

According to some example embodiments, tube 305 may have an opening at a bottom portion through which bottle 100 may be dropped. In some example embodiments, bottles 100 are maintained in tube 305 with one or more anchoring mechanisms that are configured to controllably release a bottle on demand. In some example embodiments, a movable supporting platform 207 may support bottom 140 of lower most bottle 100 in stack 200 and may intermittently retract on demand to release the lower most bottle 100. Retraction may be based on controlled rotation of platform 207 or controlled linear movement of platform 207. In some example embodiments, the rest of the bottles in stack 200 may be supported with a clasp 205 configured to clasp onto an annular rib 125. Controllable release of clasp 205 may release lower most bottle 100 on demand and clasp onto the next bottle 100 as the stack is lowered. Optionally, release of clasp 205 may be based on a pivoting movement. Optionally, stack 200 is supported by both platform 207 and clasp 205.

On demand, a bottle 100 in a collapsed state may be dropped into carriage 315. A pair of claws 310 may enclose around collapsed bottle 100 around annular rib 125 and secure bottle 100 in place (FIG. 7B). In some example embodiments, based on bottle 100 being dropped into carriage 315, stage 370 may advance carriage 315 to one or more stations to fill and dispense bottle 100. In some example embodiments, stage 370 advances carriage 315 to a capping station 331. Capping station 331 may be lowered with vertical stage 380 and a capping device 330 of capping station 331 may latch on to a cap 110 (FIG. 3) of bottle 100 while bottle 100 is in a collapsed state, rotate cap 110 in a counter clockwise direction and remove cap 110 from bottle 100. Capping station 331 may then be raised with vertical stage 380 so that carriage 315 with bottle 100 may advance to a filling device 351. Capping device 330 may continue to hold cap 110 until the bottle filling process is complete (FIG. 7C).

In some example embodiments, stage 370 proceeds to filling device 351 after de-capping of bottle 100 (FIG. 7D). Filling device 351 may include a support head 350 that has a same curvature and size as inverted upper portion 120 of bottle 100 so that it fits snuggly into collapsed bottle 100. Support head 350 may have a truncated cone shape. A nozzle 353 fitted through support head 350 is configured to attach to neck portion 115 (FIG. 1B). Optionally, nozzle 353 may screw onto neck portion 115 to maintain a tight hold on neck portion 115. Filling device 351 may be lowered toward bottle 100 and nozzle 353 may rotate to screw onto neck portion 115. Alternately, nozzle 353 may otherwise hold neck portion 115. Optionally, both capping station 331 and filling device 351 are mounted on a same platform 335 that rides on vertical stage 380. Alternatively, each of capping station 331 and filling device 351 may have a dedicated vertical stage on which it may be raised and lowered.

According to some example embodiments, filling station includes a hose 390 fluidly connected to a port 395 from which water or other beverage from an external source may be received. As water is introduced through hose 390 into bottle 100, platform 335 (or head 350) rises and bottle 100 is expanded, e.g. neck portion 115 is raised. Optionally, rising of platform 335 may be based on the pressure of the water being introduced into bottle 100. Optionally, rising of platform 335 may also be controlled by vertical stage 380. The shape and size of head 350 may facilitate expanding bottle 100, e.g. lifting upper portion 120 in a symmetric manner. Optionally, upper portion 120 may appear to peel off of support head 350 as support head 350 is raised and upper portion is expanded (FIG. 7E). Support head 350 may provide structural support for expanding bottle 100 symmetrically.

In some example embodiments, filling and expanding (or lifting upper portion 120) is performed simultaneously or concurrently. Alternatively, bottle 100 may first be expanded, e.g. upper portion 120 of bottle 100 may first be lifted and then filled. Once bottle 100 reaches its full height and is filled with water, nozzle 353 may be disengaged from neck portion 110 and platform 335 may be further lifted to allow stage 370 to advance carriage 315 back to capping station 330 (FIG. 7F). Optionally, nozzle 335 is configured to fill bottle 100 with one of a plurality of ingredients selected by a user.

Based on carriage 315 returning to capping station 331, platform 335 may be lowered to a current height of neck portion 115 and cap 110 may be secured on neck portion 115. Capping device 330 may rotate in a clockwise direction to cap bottle 100 (FIG. 7G). Once bottle 100 is capped, stage 370 may advance bottle 100 to a dispensing window 320. Dispensing window 320 may include an opening through which a customer or user may remove bottle 100 and claws 310 may release hold on rim 125 to allow a customer to remove bottle from dispensing window 320 (FIG. 7H).

According to some example embodiments, bottle 100 is filled with water, e.g. tap water from a tap line connected to filling station through port 395. In some example embodiments, water in hose 390 may be chilled with a refrigeration unit and may also be purified with one or more filters that may be integrated along a flow path of the water in hose 390 from port 395 to bottle 100. Optionally, a carbonation unit may selectively carbonate the water flowing into bottle 100. In some example embodiments, filling station may include a dispenser configured to selectively dispense additives to the water, e.g. dispense based on customer selection. Additives may be minerals and or concentrated flavors. Additives and/or flavors may be added during the water filling process so that they may be mixed in the water as bottle 100 is filled with water. Optionally, water passed through a refrigeration unit may be purified, filtered and treated prior to filling bottle 100. Optionally, water received through hose 390 may be carbonated and/or flavored.

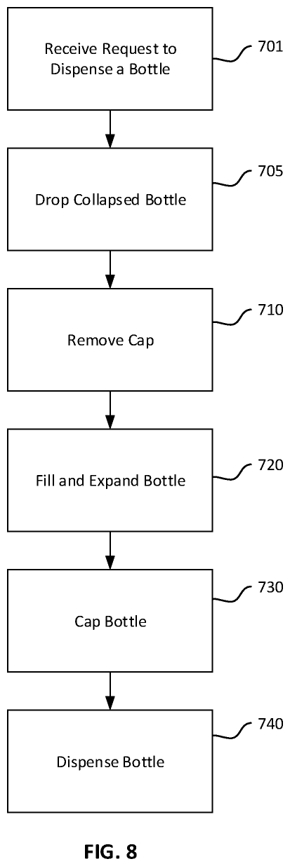

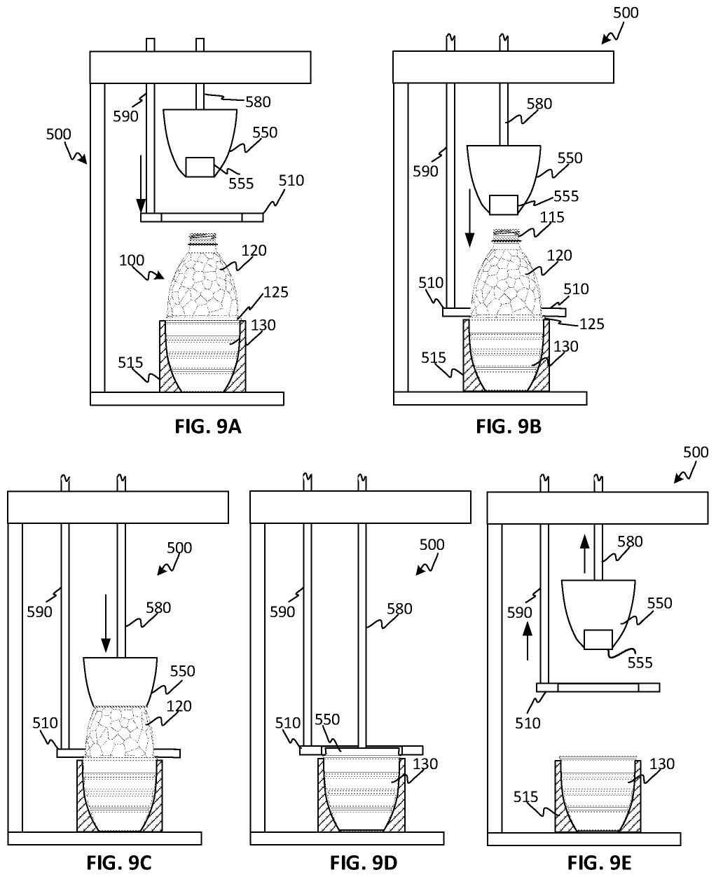

FIG. 8 is a simplified flow chart of an example method to provide a bottle filled with a beverage in accordance with some example embodiments. According to some example embodiments, when a customer approaches a filling station and requests a bottle, the command is received by the filling machine (block 701). Based on this command, a collapsed bottle from one of the stacks stored in the filling station is dropped into a carriage (block 705). In some example embodiments, the collapsed bottle is stored in the stack with a cap and the cap is removed so that the bottle may be filled (block 710). The bottle may then be engaged with a filling nozzle and may be filled with the requested beverage, e.g. water and the filling process may be accompanied with erecting of the collapsed bottle (block 720). Optionally, the beverage is tap water that is received from a source external to the filling station. Optionally, during filling, the beverage may be chilled, carbonated and/or filtered. One or more of chilling, carbonating and filtering may be based on customer selection. In some example embodiments, additives may be added to the beverage while filling. The additives may also be based on customer selection. At the termination of filling and expanding the bottle, the bottle may be capped (block 730) and the bottled and capped beverage may be dispensed to the customer (block 740). The filling station in some example embodiments is in the form of a vending machine and the bottles are filled on demand based on purchasing. FIGS. 9A, 9B, 9C, 9D, and 9E are simplified schematic block diagrams of a collapsing apparatus performing a series of example operational steps for collapsing an example self-standing bottle, all in accordance with some example embodiments. According to some example embodiments, bottles 100 are formed in a blow molding process and subsequently collapsed for compact storing of the empty bottles in a filling station. In some example embodiments, a collapsing apparatus or jig 500 includes a holder 515 configured to hold bottle 100, a plate 510 including a through going bore configured to fit around bottle 100 and pressed over annular rib 125 and a shaping head 550 configured to collapse upper portion 120 into lower portion 130 of bottle 100. Shaping head 550 may have a truncated cone shape. Optionally, shaping head 550 has a substantially same size and shape as support head 350. Optionally, plate 510 may be controllably lowered toward bottle 100 with a vertical stage 590 and shaping head 550 may be controllably lowered toward bottle 100 with a vertical stage 580. Other methods of securing and pinching annular rib 125 are contemplated. For example, one or more clasps may be mounted around holder 515 and the clasps may be configured to pinch and hold annular rib 125.

According to some example embodiments, bottle 100 that is erected and/or self standing is positioned in holder 515 (FIG. 9A). Holder 515 may be shaped and sized to snuggly hold lower portion 130 of bottle 100 up to a height of annular rib 125 with annular rib 125 exposed. Plate 510 may be lowered toward annular rib and may press against and pinch annular rib 125 between holder 515 and plate 510 without deforming upper portion 120 of bottle 100 (FIG. 9B). The pressing force may be applied by a weight of plate 510 and/or by a force applied with vertical stage 590. In some example embodiments, plate 510 secures integrity of lower portion 130 during collapsing of upper portion 120 into lower portion 130.

According to some example embodiments, shaping head 550 is lowered toward neck portion 115 (FIG. 9B, 9C and 9D).

Shaping head 550 is formed to have a same shape and size as a desired shape of upper portion 120 of bottle 100 while in the collapsed state. Optionally, shaping head is the same or similar to support head 350. According to some example embodiments, shaping head 550 is configured to completely invert (or reverse fold) upper portion 120 from neck portion 115 to annular rib 125. The inverting process begins at a seam between neck portion 115 and upper portion 120 (FIG. 9C) and advances toward annular rib 125 as shaping head 550 is lowered (FIG. 9D). A neck holding element 555 axially aligned with shaping head 550 and positioned at its lower surface is configured to engage with neck portion 115 of bottle 100. In some example embodiments, neck holding device 555 is a cavity configured to receive neck portion 115. Optionally, neck holding device 555 may additionally include a structure that is fitted into neck portion 115. In some example embodiments, neck holding element 555 includes screw threads that screw onto neck portion 115 to maintain a tight hold on neck portion 115 during collapsing. Optionally, neck holding element 555 may be similar to holding device 355. Optionally, neck holding element 555 includes at least one opening through which air from within bottle 100 may escape during the collapsing action.

According to some example embodiments, once neck holding element 555 is engaged with neck portion 115, shaping head 550 may be further pushed down until upper portion 120 collapses into lower portion 130 of bottle 100 (FIG. 9C and 9D). Shaping head 550 including neck holding element 550 may be raised along with plate 510 and bottle 100 may be removed from holder 515 (FIG. 9E). Optionally, holder 515 is mounted on a horizontal stage and may be configured to advance bottles from the collapsing apparatus to a sterilizing and capping apparatus (not shown). Alternatively, sterilization and capping may be performed in a separate assembly line.

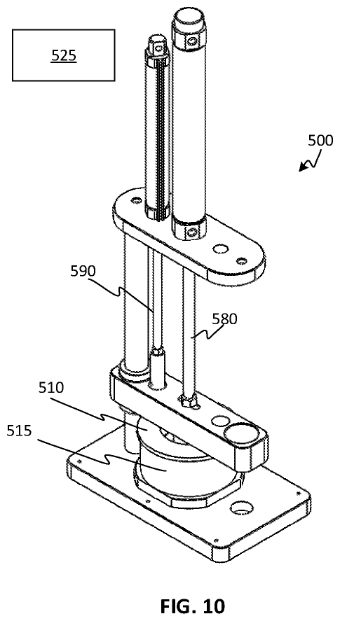

FIG. 10 shows an example collapsing apparatus configured for controllably collapsing the example self-standing bottle in accordance with some example embodiments. According to some example embodiments, movement of vertical stages 580 and 590 may be automated and controlled by a controller 525.

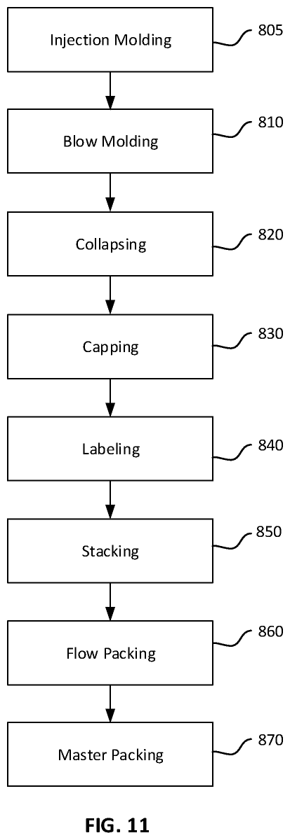

FIG. 11 is a simplified flow chart of an example method to manufacture stacks of collapsed bottles in accordance with some example embodiments. According to some example embodiments, a plurality of bottles with a defined shape and pattern on its surface may be formed based on injection molding (block 805) followed by blow molding (block 810). Optionally, bottles are PET bottles that are transparent. In alternative examples, the bottles may be formed with other plastics for example, PETG, PEN, PP, HDPE or Tritan™. In some example embodiments, the bottles are configured to hold more than 500 ml, e.g. 550 ml and to be light weight, e.g. less than 15 gm or 13 gm. Optionally, thickness of the bottle is between 0.25-0.6, e.g. 0.45. Optionally, the upper portion of the bottle may be configured to be formed from thinner material than the lower portion of the bottle. According to some example embodiments, the bottles may be defined with an aspect ratio of 0.4-0.7, e.g. 05.

The bottles maybe formed with a pattern of pseudo-random looking polygons on an upper portion of the bottle and with a plurality of indented rings encompassing a lower portion of the bottles. The bottle may also include, an annular rib formed at a seam line between the upper portion including the pattern of polygons and a lower portion including the plurality of indented rings. The annular rib may protrude outwardly as opposed to the plurality of rings that protrude inwardly with respect to an outer surface of the bottle. The bottles may be formed in an expanded state, e.g. as shown in FIG. 1B and may be self-standing even while empty. According to some example embodiments, the bottles once formed are collapsed by pushing the upper portion of the bottle into the lower portion of the bottle, e.g. as shown in FIG. 2 (block 820). Subsequently the bottle may be capped to maintain a sterilized volume in the bottle (block 830). In some example embodiments, the bottle may be labeled in a collapsed state (block 840), optionally after capping. Capped bottles may be stacked in for example stacks of 25 or more bottles in a stack, e.g. 30 bottles in a stack (block 850). Alternately, a stack may include less than 25 bottles depending on size of the filling system for which it is intended. The stacks may be package over a first stage in a flow packing process during which each stack is package in a sleeve, e.g. a nylon sleeve (block 860). A second stage of packaging may include master packing (block 870). During master packing 20-30 stacks in sleeves may be packaged in a box, e.g. carton box for shipping. The master packages may be delivered to a filling system at a point of sale.

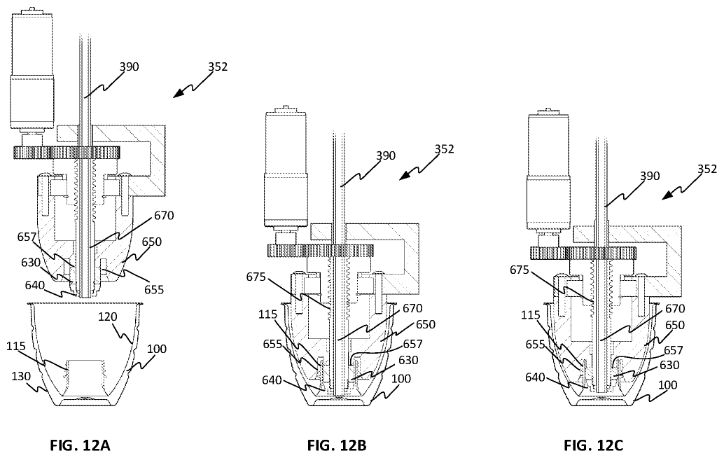

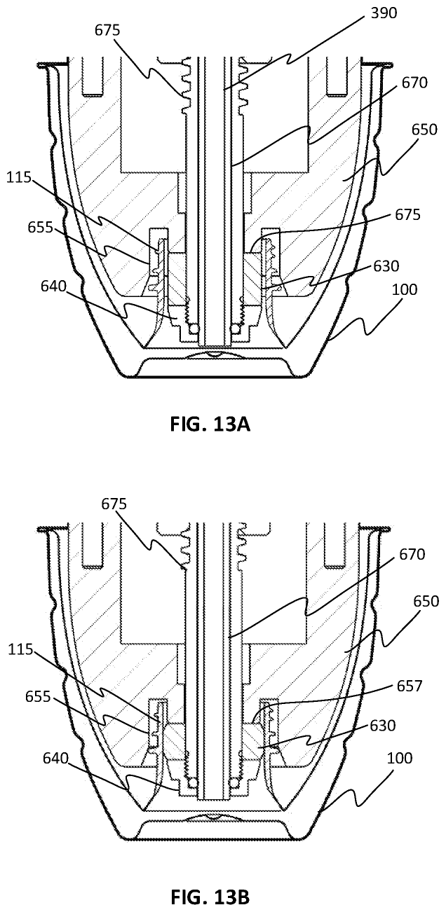

Reference is now made to FIGS. 12A, 12B, and 12C showing drawings of another example filling station shown in three different operative states and also to FIGS. 13A and 13B showing details of the example filling station engaged with a bottle in a neutral and sealed operative state respectively, all in accordance with some example embodiments. According to some example embodiments, a filling device 352 includes a support head 650 shaped to engage collapsed upper portion 120 of bottle 100 and a sealing probe 670 including hose 390 that is configured to fit into neck portion 115 to form a sealed with neck portion 115 while filling bottle 100 with hose 390. Support head 350 may have a same curvature and size as inverted upper portion 120 of bottle 100 so that it fits snuggly into collapsed bottle 100. Support head 350 may have a truncated cone shape.

According to some example embodiments, sealing probe 670 includes a sealing member 630 supported between an end cap 640 of sealing probe 670 and a surface 657 of support head 650. End cap 640 may form a nozzle through which fluid from hose 390 may flow into bottle 100. Sealing member 630 may be a ring shaped element that is elastically compressible. Optionally, an outer diameter of sealing member 630 is configured to expand by 20%-60% when compressed and may return to its neutral, e.g. unexpanded stated when the compressive force is removed.

According to some example embodiments, to fill a bottle 100, filling device 352 lowers support head 650 together with sealing probe 670 toward bottle 100 until support head 650 engages collapsed upper portion 120 and sealing member 630 is received in neck portion 115 of bottle 100.

Optionally, support head 650 includes a ring shaped recess or cavity 655 in which neck portion 115 is received. According to some example embodiments, a diameter of sealing member 630 is defined to freely fit in neck portion 115 in a neutral state (while not compressed) and to provide a sealed engagement with neck portion 115 when compressed. Optionally, sealing member 630 is compressed between end cap 640 and surface 657 based on raising height sealing probe 670 with respect to support head 650. Optionally, sealing probe 670 is raised with a screw motion including screw threads 675 by rotating sealing probe 670 in support head 650. The compressing is configured to flatten as well as expand sealing member 630 in the radial direction (FIG. 12C). Once bottle 100 is filled, the sealing engagement may be released by lowering sealing probe 670 with respect to support head 650 to release the compressive force on sealing member 630 and allow sealing member 630 to revert to its neutral geometry. In some example embodiments, filling device 352 may be used in filling station 300 in place of filling device 351.

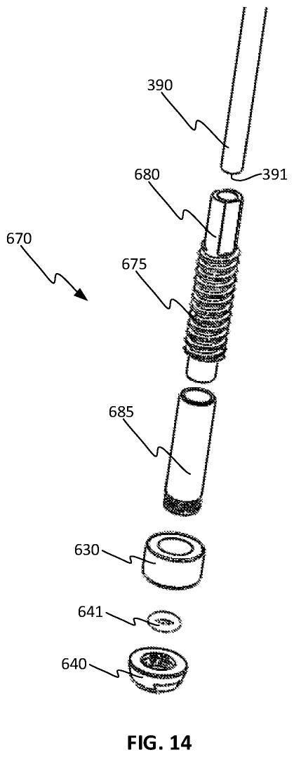

Reference is now made to FIG. 14 showing an exploded view of an example sealing probe in accordance with some example embodiments. In some example embodiments, sealing probe 670 is configured to receive hose 390 in a first pipe 680 including screw threads 675 that are configured to screw into support head 650 (FIG. 12A) and optionally a second pipe 685 that is welded to first pipe 680. A distal end 391 of hose 390 is open and may be fitted through end cap 640 with gasket 641. A bottle 100 may be filled with hose 390. End cap 640 may be fitted onto second pipe 685, e.g. may be screwed onto second pipe 685. According to some example embodiments, sealing member 630 is fitted around second pipe 685 and sits on end cap 640. First pipe 680 and second pipe 685 are screwed through support head 650 and may be raised and lowered with respect to support head 650 with a screwing motion.

It is appreciated that certain features of the invention, which are, for clarity, described in the context of separate embodiments, may also be provided in combination in a single embodiment.

Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements. In addition, any priority document(s) of this application is/are hereby incorporated herein by reference in its/their entirety.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

In addition, any priority document(s) of this application is/are hereby incorporated herein by reference in its/their entirety.

1. A bottle comprising:
a neck portion configured to receive a cap to seal the bottle;
a lower portion including a bottom on which the bottle is configured to stand erect;
an upper portion extending from the neck portion to the lower portion; and
an annular rib defining a transition between the lower portion and the upper portion,
wherein the annular rib protrudes outwardly with respect to both the upper portion and the lower portion of the bottle;
wherein the upper portion, lower portion and annular rib are portions of a single entity formed from one material, wherein the upper portion is configured to reversibly collapse into the lower portion.

2. The bottle of claim 1, wherein the bottle in its erected state is configured to be self-standing while empty.

3. The bottle of claim 1, wherein the entire upper portion between the neck portion and the annular rib is configured to be reversibly inverted.

4. The bottle of claim 1, wherein the thickness of the upper portion and the lower portion is uniform, or the thickness of the upper portion, lower portion and annular rib is uniform.

5.-8. (canceled)

9. The bottle of claim 1, wherein the bottle is formed out of a transparent polymer material.

10. (canceled)

11. The bottle of claim 1, wherein the annular rib defines the maximum diameter of the bottle and wherein both the upper portion and the lower portion taper distal from the annular rib.

12.-13. (canceled)

14. The bottle of claim 1, wherein the upper portion includes fold lines forming a pattern of polygons.

15. The bottle of claim 14, wherein the pattern of polygons is a pseudo-random pattern of polygons, the pattern of polygons including polygons with variable sizes and/or shapes.

16.-18. (canceled)

19. The bottle of claim 1, wherein the lower portion is formed with a plurality of rings protruding toward an inner volume of the bottle.

20. The bottle of claim 1, wherein the bottom is formed with a recess that is sized and shaped to receive a cap of another bottle.

21.-24. (canceled)

25. A filling station comprising:
a releasing device configured to controllably release a bottle from a stack of collapsed bottles;
a capping device configured to remove a cap from the bottle while the bottle is in a collapsed state and replace the cap after the bottle has been filled and erected; and
a filling device configured to fill the bottle with a beverage through a neck portion of the bottle concurrently with erecting the bottle from the collapsed state to an expanded state; and
a controller configured to control and coordinate operation of the releasing device, the capping device and the filling device.

26. The filling station of claim 25 comprising a dispensing window from which the bottle that is erected and filled with the beverage is dispensed.

27. The filling station of claim 25, wherein the filling device includes a support head configured to fit into a collapsed portion of the bottle and to guide erecting the collapsed portion of the bottle in a symmetrical manner.

28. (canceled)

29. The filling station of claim 27, wherein the filling device includes a nozzle configured to engage the neck portion of the bottle and fill the bottle with a beverage through the neck portion.

30. (canceled)

31. The filling station of claim 27, wherein the filling device includes a sealing probe configured to be received in the neck portion of the bottle and to form a sealed engagement with the neck portion of the bottle.

32. The filling station of claim 31, wherein the sealing probe comprises:
a pipe configured to receive a hose from which the bottle is filled with the beverage;
a sealing member fitted around the pipe, wherein the sealing member is a ring shaped element that is elastically compressible, the sealing member configured to form the sealed engagement with the neck portion of the bottle under compression; and
an end cap attached to a distal end of the pipe, wherein the sealing member is configured to sit on the end cap.

33. The filling station of claim 32, wherein the sealing member is compressed based on lifting the sealing probe with respect to the support head to press the sealing member against a surface of the support head.

34. The filling station of claim 32, wherein the seal is released based on lowering the sealing probe with respect to the support head.

35. The filling station of claim 31, wherein the sealing probe is configured to be lifted and lowered within the support head based on a screw motion.

36. The filling station of claim 25, wherein erecting of the bottle is based on pressure accumulated in the bottle as the beverage flows into the bottle.

37. The filling station of claim 25, wherein the filling device is fluidly connected to a tap water line external to the filling station.

38. The filling station of claim 37, comprising a treating unit configured to treat water received from the tap water line, wherein the filling station is configured to fill the bottle with the water treated by the treating unit and wherein the treating unit includes one or more of: a cooling unit configured to cool the tap water, a purification unit configured to filter the tap water, a carbonation unit configured to carbonate the tap water and an flavoring unit configured to add minerals and/or flavoring to the tap water.

39. (canceled)

40. The filling station of claim 25, wherein the releasing device includes a retractable platform positioned to support a bottom of the stack and to temporarily retract from the bottom of the stack to release a bottle.

41. (canceled)

42. The filling station of claim 25, comprising a carousel configured to support a plurality of stacks of collapsed bottles.

43.-48. (canceled)

49. A bottle collapsing apparatus comprising:
a holding device configured to receive a lower portion of the bottle, the lower portion including a bottom on which the bottle stands;
a gripping device configured to grip an annular rib formed on the bottle between the lower portion and an upper portion, the upper portion extending from the annular rib to a neck portion of the bottle; and
a shaping head configured with a same size and shape as an upper portion of the bottle in a collapsed state.

50. The bottle collapsing apparatus of claim 49, wherein the gripping device is configured to grip the annular rib encompassing a diameter of the bottle between the upper portion and the lower portion.

51. The bottle collapsing apparatus of claim 49, wherein the gripping device includes a plate with a bore through which the upper portion of the bottle may be erected and wherein the plate is configured to press against the annular rib.

52. The bottle collapsing apparatus of claim 49, wherein the shaping head includes a cavity configured to receive a neck portion of the bottle.

53.-56. (canceled)
